(19) United States
(12) Patent Application Publication
(10) Pub. No.: US 2017/0109621 A1
(43) Pub. Date: Apr. 20, 2017

(54) Protective Casing for a Machine Readable Tag

(71) Applicants: Phoebe L. Brown, Edmond, OK (US); Ronald E. Brown, Edmond, OK (US)

(72) Inventors: Phoebe L. Brown, Edmond, OK (US); Ronald E. Brown, Edmond, OK (US)

(21) Appl. No.: 15/089,652

(22) Filed: Apr. 4, 2016

Related U.S. Application Data
(60) Provisional application No. 62/241,313, filed on Oct. 14, 2015.

(51) Int. Cl. G06K 19/077; G06K 19/06

(52) U.S. Cl. CPC G06K 19/07728; G06K 19/06037

(57) ABSTRACT

A protective casing for a machine readable tag configured to be mounted to a tombstone. The present invention includes a protective housing having one or more sidewalls, a top wall, and a back wall that define an interior volume. An image of a machine readable tag is displayed on an interior surface of the back wall. In some embodiments, a cover is pivotally affixed to the top wall via a hinge while in alternate embodiments the cover is non-pivotally affixed to the housing. In further embodiments, the protective casing is a block of transparent material having a machine readable tag embedded therein. The protective casing is designed to protect the machine readable tag from external elements.

### CROSS REFERENCE TO RELATED APPLICATIONS

This application claims the benefit of U.S. Provisional Application No. 62/241,313 filed on Oct. 14, 2015. The above identified patent application is herein incorporated by reference in its entirety to provide continuity of disclosure.

### BACKGROUND OF THE INVENTION

The present invention relates to protective casings for barcodes. More specifically, the present invention related to protective casings for barcodes that are configured to be placed on tombstones and designed to provide information about the deceased.

Traditionally, tombstones have displayed concise amounts of information about a deceased, most often displaying not more than a name, dates of birth and death and possibly an epitaph. This amount of information has been limited due to the space restrictions offered by a standard-sized tombstone. Often family members and other loved ones wish to provide a means of relaying much more information about the deceased. However, even larger sized tombstones can be quite limited in space. Additionally, it is often not viewed as societally appropriate to list more that basic information about a deceased on the tombstone where it is visible to all.

There have been a number of solutions suggested in the prior art to address this issue. One such invention discloses a computer readable memory stick that holds extensive information about an individual, where the memory stick is configured to be embedded within a tombstone and accessible to visitors. This requires a visitor to have a device on hand that has a physical means of accessing the memory stick. An additional solution provided in the prior art includes a system for accessing information remotely using a mobile electronic device such as a camera to capture an image of the deceased person, and using that image to identify a matching image in a database that contains more information about the deceased person. This requires a device with sufficient image resolution to provide a picture that is easily identifiable to a matching system, requiring sophisticated and potentially expensive hardware and software to ensure low matching failure rates for reliable performance.

A third solution includes a machine readable tag that is affixed to a tombstone and is designed to be easily read by a basic image capturing device. However, the limitation of this approach is the difficulty in ensuring that the machine readable tag will be sufficiently durable in an outdoor environment of a cemetery so that the code will remain easily identifiable by a basic image capturing device.

Therefore, there is a need in the prior art for a device that can display a machine readable tag in a permanent manner than will not fade over time or with exposure to the elements, wherein the tag can relay much more information about a deceased than the basic information provided on a tombstone, either integrally within the tag or by redirecting the user to information stored in a remote database.

### SUMMARY OF THE INVENTION

In view of the foregoing disadvantages inherent in the known types of protective cases and tombstones now present in the prior art, the present invention provides a protective casing for a machine readable tag wherein the same can be utilized for providing convenience for the user when wishing to access information about a deceased person that is additional to basic information displayed on a tombstone. The present invention includes a back wall on which an image of a machine readable tag is positioned, sidewalls extending therefrom, and an open front. A cover is connected to a top wall and can be attached thereto with or without a hinge. It is designed to protect the machine readable tag from external elements. The invention can be mounted directly to a tombstone or to another surface such as the top of a post.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the protective casing for a machine readable tag.

FIG. 2 shows a perspective view of an alternative embodiment of the protective casing for a machine readable tag.

FIG. 3 shows a perspective view of an embodiment of a tombstone with the protective casing for a machine readable tag installed thereon.

FIG. 4 shows a perspective view of an embodiment of the protective casing for a machine readable tag mounted onto a post.

FIG. 5 shows a perspective view of an alternative embodiment of the protective casing for a machine readable tag.

### DETAILED DESCRIPTION OF THE INVENTION

Reference is made herein to the attached drawings. Like reference numerals are used throughout the drawings to depict like or similar elements of the protective casing for a machine readable tag. The figures are intended for representative purposes only and should not be considered to be limiting in any respect.

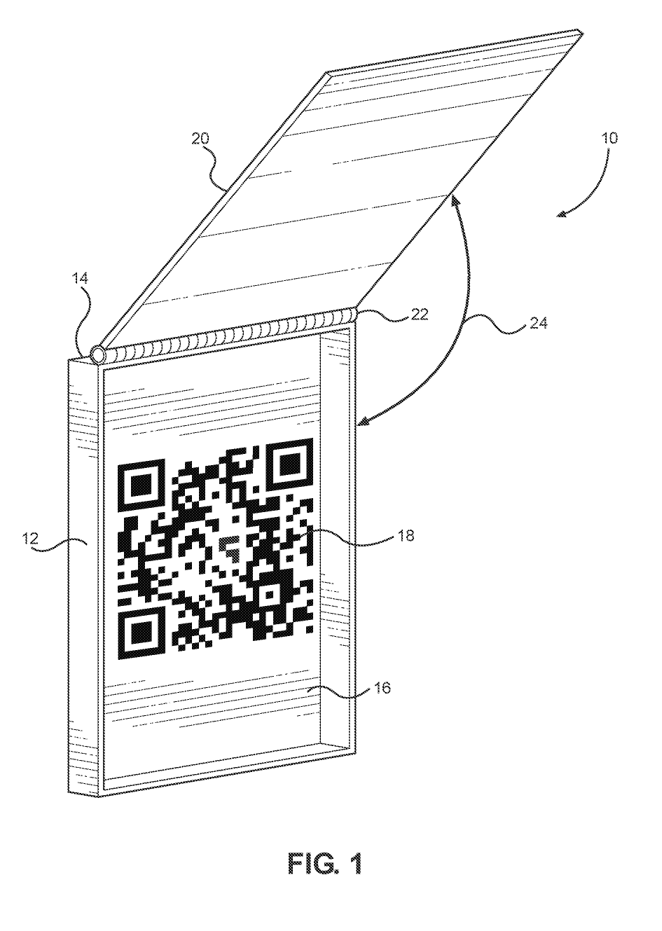

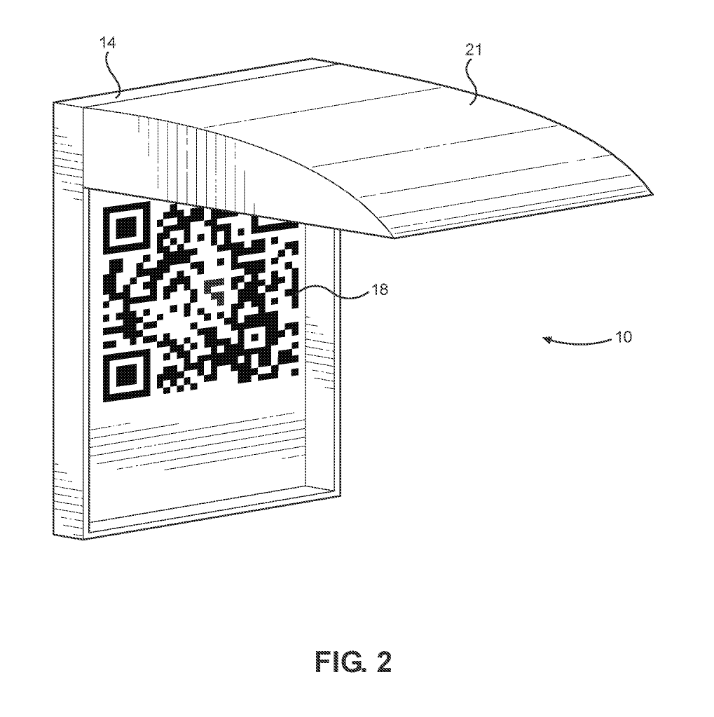

Referring now to FIGS. 1 and 2, there are shown perspective views of an embodiment of a protective casing for a machine readable tag. The protective casing 10 comprises a housing having one or more sidewalls 12, a back wall 16 and a top wall 14 that define an interior. An image of a machine readable tag 18 is displayed on the back wall 16. A cover 20 is connected to the top wall 14 and configured to protect the machine readable tag 18.

In some embodiments of the invention, a cover 20 is hingedly attached to the top wall 14 and configured to rotate 24 between an open position and a closed position. In the closed position, the cover 20 encloses the interior volume of the housing so as to protect the machine readable tag therein. For example, the cover 20 can be mounted to the top wall 14 with a continuous hinge 22. Alternatively, the cover 20 and the housing can be molded from a single piece of material and connected via a live hinge composed of a thin strip of the same material. This can be accomplished using various forms of hardened plastic, in addition to other suitable materials. The hinge 22 can also be adapted to incorporate a spring, such as a torsion spring, that is configured to bias the cover 20 toward a closed position. When a user wishes to view the machine readable tag 18, they may lift the cover 20 and reveal the interior of the protective housing 10.

In alternative embodiments of the protective casing, the cover is non-rotatably attached to the housing. A stationary cover 21 is mounted to the top wall 14 in a rigid fashion at a substantially perpendicular angle to the sidewalls 12. The cover 21 is positioned to provide protection from outdoor elements such as sun and rain without the need for incorporating a hinge. Furthermore, a single-piece construction can offer a version of the protective casing that is more economical to produce.

The machine readable tag 18 can be a one dimensional or a multi-dimensional barcode. In some embodiments of the invention, the machine readable tag 18 is a two dimensional barcode such as a Quick Response (QR) code. The machine readable tag 18 can be affixed to the back wall 16 using various methods. In some embodiments of the invention, the machine readable tag 18 is printed directly onto the surface of the back wall 16. In other embodiments of the invention, the machine readable tag 18 is printed onto an adhesive surface and affixed to the back wall 16. In yet another embodiment of the invention, the machine readable tag 18 is etched or embossed directly into the material of the back wall 16.

The machine readable tag 18 can either contain information about the deceased that is integrally embedded within the tag. For example, a QR Code version 40 can have a capacity of more than 4000 alphanumeric characters, which can be programmed to contain information about the deceased. Alternatively, the machine readable tag 18 can direct a user to information stored at a remote location, such as on a website or a database accessible through the internet. The information can contain text, images, videos or various combinations of all three that can be viewed on a mobile electronic device.

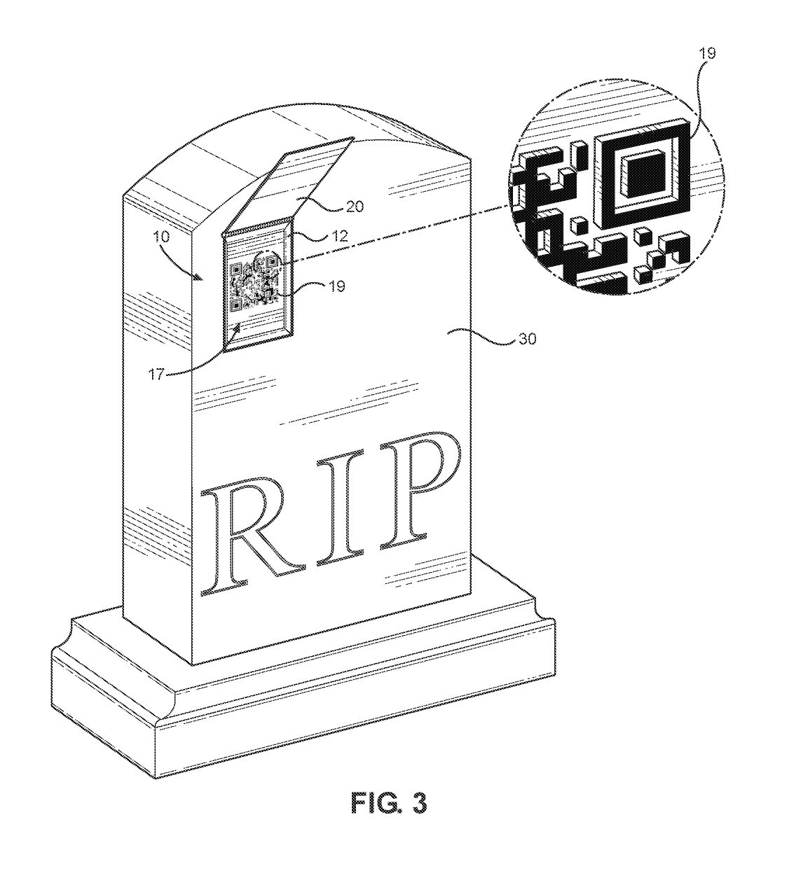

Referring now to FIG. 3, there is shown a perspective view of an embodiment of a tombstone with a protective casing for a machine readable tag installed thereon. In some embodiments of the invention, the machine readable tag 19 is engraved or embossed directly into the tombstone 30. In this embodiment, the protective casing 10 is configured to be attached directly to the tombstone 30 and positioned to protect the engraved or embossed readable tag 19. There can be a recess 17 in the stone 30 around the readable tag that is sized for the protective casing 10 to be inserted therein. Alternatively, grooves that are dimensioned to fit the sidewalls 12 and top wall 14 to a close tolerance may be etched into the stone 30 around the readable tag 19.

In some embodiments, the cover 20 is attached to the protective casing 10 with a hinge and can be rotated between an open and a closed position. In other embodiments, the cover is non-rotatably attached to the protective casing 10. Similar to the previously disclosed embodiments, the cover 20 is configured to protect the readable tag 19 from the outdoor elements.

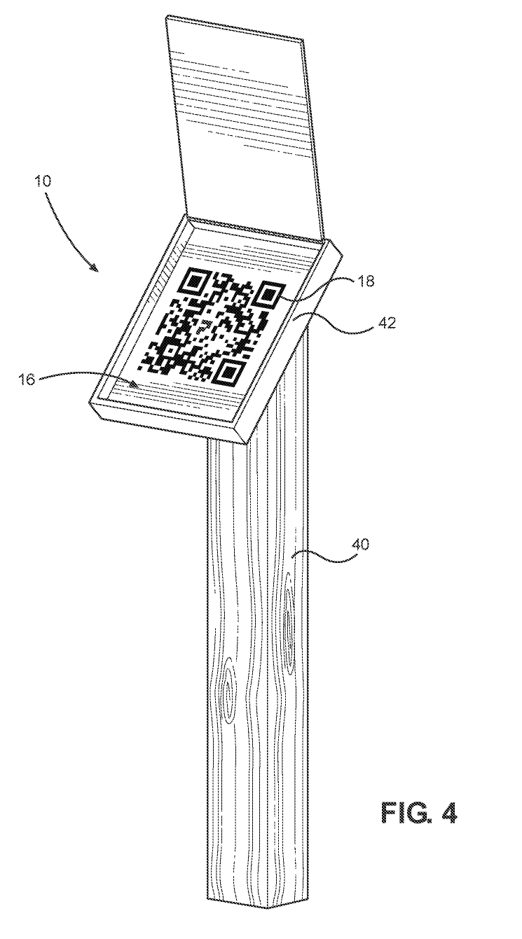

Referring now to FIG. 4, there is shown a perspective view of an embodiment of a protective casing for a machine readable tag mounted onto a post. The protective casing 10 is mounted onto a post 40. This provides an alternative setup for access to the machine readable tag 18 where it is inconvenient to affix the protective casing 10 directly to a tombstone 30. For example, if the tombstone 30 is made from a material that is not conducive to using adhesives, or if it is not possible to engrave the machine readable tag 18 directly onto the stone, a free standing structure such as a post 40 offers an alternative place for the protective casing 10. Additionally, the protective casing 10 can be mounted on a post 40 for alternative purposes, such as to mark a memorial or tree that has been planted in memory of the deceased.

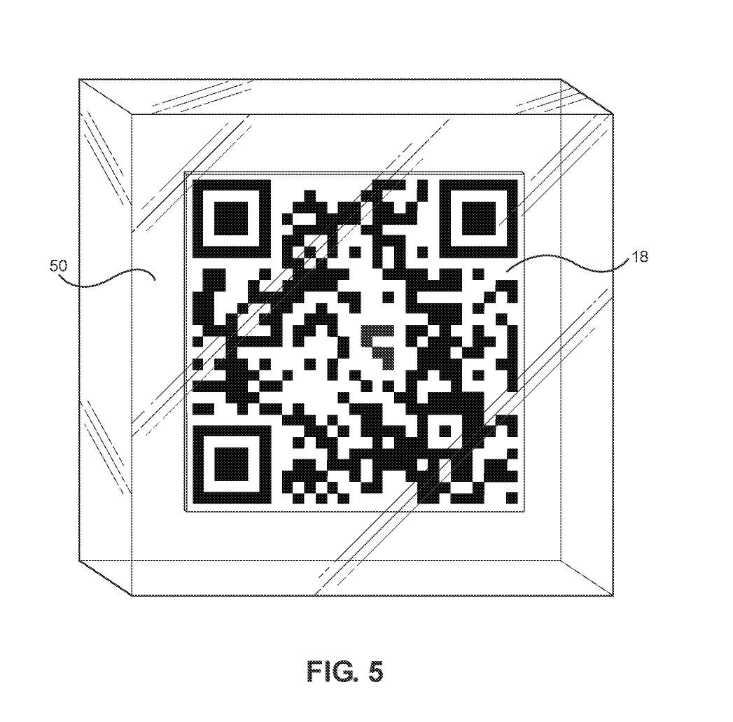

Referring now to FIG. 5, there is shown a perspective view of an alternative embodiment of the protective casing for a machine readable tag. In some embodiments of the invention, the protective casing comprises a rectangular block of transparent material 50. The machine readable tag 18 is disposed within the transparent material 50, and is visible from the exterior of the rectangular block. In some embodiments of the invention, the transparent material 50 is an acrylic polymer. For example, the transparent material 50 can be polymethyl methacrylate, commonly known as Plexiglas. In some embodiments of the protective casing, the machine readable tag 18 is etched directly onto the transparent material 50. In other embodiments of the protective casing, the machine readable tag 18 is printed onto a separate element that is inserted into the rectangular block of transparent material 50.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A protective casing for a machine readable tag, comprising:
a housing comprising one or more sidewalls, a top wall, and a back wall defining an interior;
a cover connected to the top wall;
an image of a machine readable tag displayed on an interior surface of the back wall.

2) The protective casing for a machine readable tag of claim 1, wherein the machine readable code is a two dimensional barcode.

3) The protective casing for a machine readable tag of claim 1, wherein the machine readable code is etched onto the back wall.

4) The protective casing for a machine readable tag of claim 1, wherein the cover is hingedly connected to the top wall.

5) The protective casing for a machine readable tag of claim 4, further comprising a torsion spring configured to bias the cover toward a closed position

6) The protective casing for a machine readable tag of claim 1, wherein the cover is non-rotatably attached to the top member and positioned substantially perpendicular to the interior.

7) A tombstone having a machine readable code, comprising:
a stone comprising an exterior surface having a two dimensional barcode engraved thereon;
a grooved channel circumscribed around the two dimensional barcode;
a housing comprising one or more sidewalls and a top wall, wherein the sidewalls are configured to be securely mounted within the grooved channel;
a cover connected to the top wall.

8) The protective casing for a machine readable tag of claim 7, wherein the machine readable code is a two dimensional barcode.

9) The protective casing for a machine readable tag of claim 8, wherein the machine readable code contains alphanumeric information stored therein.

10) The protective casing for a machine readable tag of claim 7, wherein the cover is hingedly connected to the top wall.

11) The protective casing for a machine readable tag of claim 10, further comprising a torsion spring configured to bias the cover toward a closed position

12) The protective casing for a machine readable tag of claim 10, wherein the cover is non-rotatably attached to the top member and positioned substantially perpendicular to the interior.

13) A protective casing for a machine readable tag, comprising:
a housing comprising a rectangular block of transparent material;
an image of a machine readable tag positioned therein.

14) A protective casing for a machine readable tag of claim 13, wherein the transparent material comprises an acrylic polymer.

15) A protective casing for a machine readable tag of claim 13, wherein the image of a machine readable tag is etched within the transparent material.
